(19) United States
(12) Patent Application Publication
(10) Pub. No.: US 2014/0310006 A1
(43) Pub. Date: Oct. 16, 2014

(54) METHOD TO GENERATE AUDIO FINGERPRINTS

(71) Applicants: Xavier Anguera Miro, Barcelona (ES); Antonio Garzon Lorenzo, Valladolid (ES); Tomasz Adamex, Madrid (ES)

(72) Inventors: Xavier Anguera Miro, Barcelona (ES); Antonio Garzon Lorenzo, Valladolid (ES); Tomasz Adamex, Madrid (ES)

(73) Assignee: TELEFONICA, S.A., Madrid (ES)

(21) Appl. No.: 14/241,665

(22) PCT Filed: Jul. 4, 2012
(86) PCT No.: PCT/EP2012/062954

§ 371 Date: Jun. 3, 2014

Related U.S. Application Data
(60) Provisional application No. 61/528,528, filed on Aug. 29, 2011.

(51) Int. Cl. G10L 19/018; G10L 19/002; G10L 19/02

(52) U.S. Cl. CPC G10L 19/018; G10L 19/02; G10L 19/002
USPC 704/500

(57) ABSTRACT

It is characterised in that it comprises:
a) centring a mask in a spectral peak of a plurality of spectral peaks of a spectrogram of an audio signal;
b) defining spectral regions around said spectral peak by means of said mask;
c) capturing average energies of each of said spectral regions;
d) comparing each of said average energies between them;
e) obtaining a bit for each comparison, each obtained bit indicating the result of each comparison;
f) grouping each bit obtained by means of said comparison in order to constitute an audio fingerprint; and
g) encoding of the encoded spectral peaks using coarse frequency bands in order to allow for fast comparison of fingerprints

### FIELD OF THE ART

The present invention generally relates to a method to generate audio fingerprints, said audio fingerprints encoding information of audio documents and more particularly to a method that comprises encoding the local spectral energies around each of the main spectral peaks in a spectrogram of an audio signal.

### PRIOR STATE OF THE ART

Audio fingerprinting is understood as a compact way to represent the audio signal so that is convenient for storage, indexing and comparison of audio documents. It is very important that such fingerprints are robust to many common audio transformations. In other words, a good fingerprint should capture and characterize the “essence” of the audio content. More specifically, the quality of a fingerprint can be measured in several ways. One of them is discriminability (or discriminatory power). A fingerprint has a high discriminatory power if two fingerprints extracted from the same location in two audio segments coming from the same source are very similar, and at the same time, fingerprints extracted from segments coming from different sources to be very different. Another quality is robustness to acoustic transformations. A transformation is defined as any alteration of the original signal that modifies the physical characteristics of the signal but still allows a human to judge that such audio comes from the original signal. Typical transformations include MP3 encoding, sound equalization and mixing with external noises or signals. Last but not least, compactness is also important to reduce the amount of information that needs to be compared when using fingerprints in order to search in large collections of audio documents.

In recent years there have been several proposals for different ways to construct acoustic fingerprints [1]. Most of them are not robust enough to severe audio transformations, they are focused only on encoding music information or are expensive to compute or to store.

The Shazam fingerprint [2] encodes the relationship between pairs of spectral peaks. The system first converts the input signal into its frequency representation, using the Fourier transformation, and then finds suitable peaks in the spectrum. The frequency peaks are considered to be robust to acoustic transformations to the signal and is the property that is directly or indirectly encoded by all acoustic fingerprinting algorithms reviewed here. In the Shazam system, once all peaks have been found, a set of anchor peaks are selected. However, the exact way in which such anchors are chosen is not explained in their paper. For each anchor peak a target region is selected, which is a region in the spectrogram from which each peak is encoded together with the corresponding anchor. The resulting fingerprint is composed of 32 bits, from which 10 bits are used to encode the exact frequency location of each of the two peaks (the anchor and each one of the peaks in the target region) and 12 bits are used to encode the time difference between such pair of peaks.

The Philips system [3] encodes the acoustic signal sequentially in time, i.e. it stores a 32 bit fingerprint for every fixed time step. The input signal is also transformed to the frequency domain and then a BARK scale filtering is applied to it in order to adapt the frequency data to the way that humans perceive it. In their implementation they use 33 BARK filters, thus obtaining a 33 dimensional vector for each time step. Next, each of these vectors is encoded into a fingerprint by comparing the energy values in every pair of adjacent bands. In particular, they combine the difference between every two adjacent bands both in the current time step and in the previous one. Depending on the result of such comparison they set a single bit in the fingerprint to 0 if it is negative or to 1 otherwise.

Finally, the system proposed by Google (which they call WavePrint) [4] applies image processing techniques to obtain a sequential encoding of the input signal. First they transform the audio signal into the frequency domain and apply a 32-band BARK filtering to reduce its dimensionality. Up to this point the processing is done in a very similar way as in the Philips system. Then, they apply an iterative 2-dimensional HAAR wavelet transformation to blocks of the spectral data with a length of approx. 1.5 seconds each. Such transformation of a fixed-length 2-dimensional slice of the spectrum, typical in image processing applications, results in a 2-dimensional matrix of the same size, with all transformation coefficients located in their respective locations in the space. Next, only those coefficients that have the highest absolute magnitude are selected, turning to 0 the rest. Finally, they encode all coefficients in the matrix by using 2 bits per coefficient (encoding positive, negative and zero values) and store them using a min-hash algorithm to reduce the storage space required. Although the resulting fingerprint is much longer than 32 bits, its advantage is that it is extracted much less frequently that the fingerprint in the Philips system.

The fingerprints explained above constitute the state of the art of audio fingerprinting both in industry and in academic circles, from which many technical papers have been derived. Still, they have several drawbacks that are described next.

The Shazam fingerprint [2] encodes the relationship between two spectral maxima. By encoding multiple maxima in a single fingerprint they are more prone to errors due to acoustic transformations altering either of the maxima. For this reason, in order to make the system robust, for each selected anchor point they need to store several fingerprints by combining each anchor point with other maxima within its target area. This creates an overhead of data to be stored for each anchor point that makes it important to devise robust techniques to select the appropriate anchor points so that they are less likely to be altered by any transformation. It is desirable that local features based on spectral peaks encode each peak individually making it more robust to audio transformations, i.e transformation affecting a single peak would not affect neighboring fingerprints. Or in other words, smaller number of features (fingerprints) would be needed to achieve the same robustness level. It would also allow for techniques to detect the spectral maxima to be more relaxed and simplified. Finally, another drawback of the Shazam system is that it encodes the data inside the fingerprint in 3 different blocks (20 bits for the frequency locations of the two peaks and 12 bits for their time difference). If the comparison between fingerprints is allowed some error they need to first apply a conversion from binary form to the corresponding natural numbers and later differentiation to find how far the spectral maxima are from each other. Given that the fingerprint comparison step is the most repeated step in any retrieval algorithm it would be much better if such comparisons could be performed entirely in the binary domain or lead by simple comparison table lookups (which is unfeasible here due to the big number of possible values used in the frequency and time encoding).

The Philips fingerprint [3] encodes the signal sequentially, which reduces its flexibility to adapt its storage requirements to different application scenarios. For example, for a server-based solution without any storage problems it is desirable to store as many fingerprints as are available, while for a solution embedded in a mobile device it is required to reduce the number of computed fingerprints to save on computation and bandwidth if they need to be sent to a server for comparison with a database. In the Philips system one can only achieve this by changing the fingerprint extraction step, but this can severely change the resulting fingerprints and thus the final performance. Furthermore, in the encoding step, Philips solution relies on the energy differences between pairs of band energies, and encodes all bands in each time step. It is well known that the hard binary encoding of the comparison of just the values of two adjacent bands is prone to any small fluctuation in the signal. This can cause instability in certain bits and affect its robustness. In addition, by encoding all the bands in the spectral domain at every analysis step the system is more prone to errors in regions where the overall energy is very low and where differences in energy are due to very small energy noises added to the signal, which change arbitrarily depending on the transformations applied to the audio. It would be advisable to modify such fingerprint in a way that spectral regions with higher energy be compared every time and to avoid encoding the regions with very low energy.

Finally, the Google system [4] proposes an alternative encoding of the audio by using the wavelet transformation. Such approach is indirectly encoding the peaks in the spectra as indicated by the biggest coefficients in the wavelet domain. Even though their approach seems more robust than the previous two approaches, it is computationally very expensive and results in a high number of bits per fingerprint, thus making its computation in an embedded platform or its transmission through slow channels (for example the mobile network) very impractical.

### DESCRIPTION OF THE INVENTION

It is necessary to offer an alternative to the state of the art, which covers the gaps found therein, particularly related to the lack of proposals which really present an efficient technique to generate robust and discriminative fingerprints reducing the required storage.

To that end, the present invention provides a method to generate audio fingerprints, said audio fingerprints encoding information of audio documents.

On the contrary to the known proposals, the method of the invention, in a characteristic manner, comprises:

a) centering a mask in a spectral peak of a plurality of spectral peaks of a spectrogram of an audio signal;

b) defining spectral regions around said spectral peak by means of said mask;

c) capturing average energies of each of said spectral regions;

d) comparing each of said average energies between them;

e) obtaining a bit for each comparison, each obtained bit indicating the result of each comparison; and

f) grouping each bit obtained by means of said comparison in order to constitute an audio fingerprint.

g) encoding of the encoded spectral peaks using coarse frequency bands in order to allow for fast comparison of fingerprints, for example via a table lookup method.

In an embodiment, in order to generate a plurality of audio fingerprints the step a) is performed in different spectral peaks of said plurality of spectral peaks.

Moreover, the obtained values of each bit from the comparison of step e) depend on the spectral region that has a higher average energy according to the comparison.

In another embodiment, the position of the spectral peak included in the audio fingerprint is quantized using any rough quantization of the frequency, like a Mel-spectrogram or any similar frequency bandpass filtering method.

Also, a time-to-frequency transformation to said audio signal is performed and it is possible to apply a Human Auditory System filtering to the frequency transformation in order to obtain said spectrogram, previous to said step a).

Then, the spectral peaks of the spectrogram are selected by means of selecting one of the following criteria to be applied: local maxima of said spectrogram, local minima of said spectrogram, inflection points of said spectrogram or derived points of said spectrogram

Other embodiments of the method of the invention are described according to appended claims 7 to 20 and in a subsequent section related to the detailed description of several embodiments.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows a block diagram of the steps involved in the fingerprint extraction, according to an embodiment of the present invention.

FIGS. 2, 3 and 4 show examples of masks applied to spectral peaks of an audio file, according to an embodiment the present invention.

FIG. 5 shows an example application of an example mask encoding a salient peak in an 18-bands spectrogram, according to an embodiment of the present invention.

FIG. 6 shows the process of placing information inside the fingerprint, according to an embodiment of the present invention.

### DETAILED DESCRIPTION OF SEVERAL EMBODIMENTS

This report describes a novel audio fingerprint that effectively encodes the information existent in audio documents to be later used to discriminate between transformed versions of the same acoustic documents and other unrelated documents. The fingerprint has been designed to be resilient to strong transformations of the original signal and to be usable for all sorts or audio, including music, speech and general sounds. Its main characteristics are its locality, binary encoding, robustness and compactness. The proposed audio feature is local because it encodes the local spectral energies around each of the main spectral peaks in a signal's spectrogram. The encoding of each spectral peak is done by centering a carefully designed mask on it which defines regions of the spectrogram whose average energies are compared with each other to obtain the values for the bits in the fingerprint. Given that regions are usually composed of multiple spectral values, such comparisons are more robust than existing proposals. From each comparison a single bit is obtained depending on which region has more energy, and all bits are grouped into a final fingerprint. In addition, it is also included in the fingerprint the position of each peak quantized using any rough quantization of the frequency, like for example the Mel-spectrogram bands. The final fingerprint can have as little as 16 bits, although it is usual to create fingerprints with up to 32 or 64 bits. Typically, extracting from 50 to 100 of such fingerprints per second provides good discriminatory power needed to distinguish between different audio documents. In fact, this number can be set depending on the application by using different methods and parameters for selection of spectral peaks. Given that each fingerprint is created solely from the information around one spectral peak, it is less susceptible to errors and occupies less space than existing proposals.

Next it will be described in detail the extraction of the proposed MASK fingerprint from an audio signal. The processed signal can either be a static file (where it is known a priori its start and end times) or streaming audio. The only requirement is to have a big enough acoustic buffer around each selected peak to be described, so that the extraction mask can be centred at the peak. In practical terms it is usually sufficient for the buffer to be between 100 ms and 300 ms long.

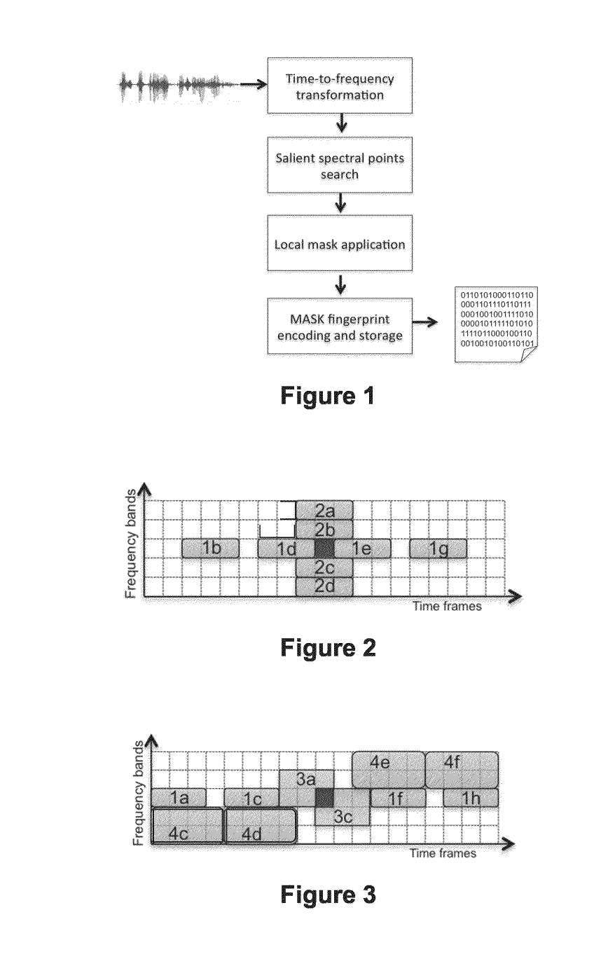

The MASK fingerprint extraction is composed of 4 main blocks, as shown in FIG. 1. First, the input signal is transformed from the time domain to the spectral domain, where all the remaining extraction steps take place. Then, spectral salient points that possess certain characteristics that make them robust to modifications of the audio, are selected. These points, referred also as spectral keypoints, will serve as center points for the extraction of local fingerprints. Next, for each one of the salient points a mask is applied around it and the grouping of the different spectrogram values into regions is performed, as defined by such mask. Finally, the last step compares the averaged energy values of each one of these spectrogram regions to determine a fixed length binary descriptor. This local descriptor forms the proposed MASK fingerprint (also referred to as MASK feature), extracted independently for every salient point. Next sections describe in more detail each one of these steps.

Time-To-Frequency Transformation

In order to find the spectral peaks it is necessary to compute the spectral representation of the input signal. Such process can be done in several ways. One alternative is to compute a short term-FFT (Fast Fourier Transform) on the signal at fixed time intervals and use a short-term window. In addition to simply using the FFT one can later apply some Human Auditory System (HAS) filtering to equalize the frequency bins to values that correspond to the human perception of audio. Moreover, HAS filtering also reduces the number of total frequency bins. There are several ways to implement such filtering, being MEL and BARK filter banks the most common and simple to apply. Finally, a third alternative, more oriented towards streaming applications, is the application of bandpass filters to the temporal signal in order to obtain the energy values for a set of selected frequency bands directly from the input signal. In the preferred implementation it is used the short-term-FFT with MEL filtering. However, it should be stressed that, the proposed MASK fingerprint could be extracted using any of the above mentioned, or similar, alternatives.

To apply such transformation the signal is first down-sampled to 5 KHz or even 4 KHz, single channel, and the short-term-FFT is applied over a 100 ms acoustic segments, previously filtered using an anti-aliasing window (for example a Hamming window) to reduce the borders effects in the spectrogram. Then a MEL filter bank of size 18 or 34 is applied over the frequency range between 300 Hz and 2 KHz to obtain a final vector. This processing is done for every 10 ms of input signal. Note that bigger frequency ranges (for example up to 4 or 8 KHz) and more MEL bands can be computed with very little variation in the final fingerprint. In the rest of this description they will just be considered the 18 and 34 band cases.

Extraction of Spectrogram Peaks

Once the spectral representation of the signal has been obtained, it is necessary to select salient points in the spectral domain wherein centering the computation of the proposed MASK fingerprint. There are several possible criteria for the selection of salient points, such as: (i) local maxima of the spectra (i.e. spectral peaks), (ii) local minima, (iii) their inflection points or (iv) other derived points (e.g. the centroid of all peaks for a certain time frame). In the preferred implementation the local maxima is used as it is resilient to many audio transformations. In general, a local spectral maxima or spectral peak can be defined as any point in frequency whose energy is greater than the points adjacent to it, either in frequency, time or in both.

In addition to selecting local energy maxima, usually some other constraints are applied to narrow down the number of salient points. One such constraint can be the number of fingerprints the designer of the system desires to encode per second (i.e. the density of salient points). The more peaks selected the bigger the storage needs are; and on the contrary, the easiest it is to find matching points between two altered signals originally coming from the same source. Some observations indicate that a good coverage of the audio is obtained by extracting between 50 and 100 peaks per second. This flexibility allows lowering the number of peaks for certain applications with strong memory or transmission limitations, or otherwise incrementing it in server-based solutions with big processing and storage capabilities. Other constraints that can condition the selection of any given peak are their absolute energy values (peaks with smaller energy values are a priori more prone to become errors), the elimination of smaller peaks close to higher energy ones, etc.

In one possible embodiment of the invention the peaks selection method can be made quite simple. A time-frequency position in the spectrogram E(t,f) is selected as a peak if E(t,f)>E(t+1, f) and E(t,f)>E(t−1, f) and E(t,f)>E(t, f+1) and E(t,f)>E(t, f−1), where t+/−1 are the time frames right before and after the current position, and f+/−1 are the frequency positions right before and after the current frequency. In this particular implementation the number of extracted peaks is not limited or the extracted peaks are not conditioned to their energy value. It has been observed that this usually returns a reasonable number of peaks, in average between 90 and 120 peaks per second, although some of these peaks might not be very reliable in retrieval applications as their absolute energy can be quite low. Note that according to the definition of the peaks obtained, a peak is never considered for the top or bottom-most MEL bands, leaving only 16 or 32 possible peak positions.

The process of characterizing the region around each detected spectral peak using the fingerprint mask will be described later. In addition to the information extracted in peak's neighbourhood, the final fingerprint also encodes the frequency where the peak was found. However, differently from other proposals, it is encoded directly the band number within the frequency band where the peak was found (which in this embodiment corresponds to the MEL band). Standard values of the MEL filter bank used in the implementations are 18 and 34 bands. Therefore peaks' MEL bands can be encoded with 4 or 5 bits respectively.

Extraction of Spectrogram Peaks

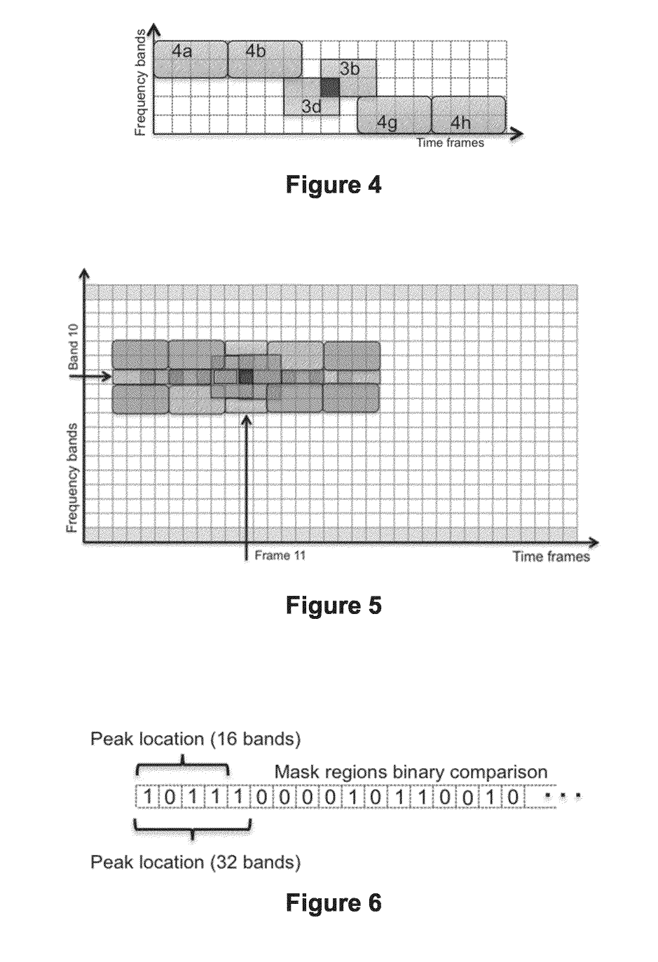

Once the spectrogram peaks have been detected a mask is applied centred at each of the salient peaks. This defines regions of interest around each peak that are used for encoding the resulting binary fingerprint. The encoding is carried out by comparing differences in average energies between certain region pairs. A region in the mask is defined as either a single time-frequency value or a set of spectrogram values that are considered to contain similar characteristics (they are usually contiguous in time and/or frequency). When a region is composed of several values its energy is represented by arithmetic average of all its values. The different regions defined in the mask are allowed to overlap with each other. The optimum location and size of each region in the mask, as well as the total number of regions, can vary depending on the kind of audio that is being analysed and the number of total bits desired for the fingerprint. A possible generic mask is shown in FIGS. 2, 3 and 4. This mask example covers 5 MEL frequency bands around the peak—2 bands above and 2 bands below—and extends for 190 ms—90 ms before and 90 ms after. Different regions grouping together several spectral values are labelled using a numeric value followed by a letter. This specific way of labelling has been chosen to simplify the explanations next.

Note that when a salient peak is found either at the band N−1 or at band 2 (i.e. with only one band above or below it) the mask in FIGS. 2, 3 and 4 cannot be placed correctly centred around that peak as either the first or last rows would fall outside of the spectrogram limits. In such case the values of the first/last available band are duplicated to cover the inexistent values for the first/last mask rows. The regions and the final fingerprint are defined in a way that such redundancy does not affect much the properties of the resulting fingerprints.

In order to exemplify the application of the mask in a real MEL-filtered spectrogram, in FIG. 5 it is shown an example for an 18-bands case. Given a salient peak found in frame 11 and band 10 the mask shown in FIGS. 2,3 and 4 is placed centred in such maxima, and the average energies of all spectrogram positions within each of the regions is computed to later construct the final fingerprint. Note that although the first and last MEL bands are not considered as possible maxima holders, their values can be used for the construction of the fingerprint if the mask includes them.

Fingerprint Construction

In this step the fingerprint characterizing each peak is constructed by combining both, the index of the frequency band where the peak being described was found, and the information from the masked area around it. The present invention aims at the construction of an up to 32 bits long fingerprint, which is sufficient for the indexing and retrieval of a very large number of audio documents. Future extensions to 64 bits are possible and very straightforward by just redefining the mask and extending the set of comparisons between its regions.

FIG. 6 shows the location of the different bits in the fingerprint. The information in the fingerprint is structured as follows: first, a block of 4 or 5 bits is inserted encoding the location of the salient peak within the 16 or 32 MEL-filtered spectral bands where maxima can be located. Next to the spectral band encoding, the binary values resulting from the comparison of selected regions around the salient peak are inserted, as defined by the mask. The following table shows a set of possible region comparisons described for the example mask in FIG. 5. In this example the obtained bits can be split into 5 main groups. The first and second groups encode the horizontal and vertical evolution of the energy around the salient peak. The third group compares the energy around the most immediate region around the salient peak, while the fourth and fifth groups encode how the energy is distributed along the furthest corners in the mask. In total, in the following table defines 22 bits. More bits can be easily obtained by encoding alternate comparisons of regions.

| | | |
|---|---|---|
| Bit number | Region 1 | Region 2 |

Horizontal max

| | | |
|---|---|---|
| 1 | 1a | 1b |
| 2 | 1b | 1c |
| 3 | 1c | 1d |
| 4 | 1d | 1e |
| 5 | 1e | 1f |
| 6 | 1f | 1g |
| 7 | 1g | 1h |

Vertical max

| | | |
|---|---|---|
| 8 | 2a | 2b |
| 9 | 2b | 2c |
| 10 | 2c | 2d |

Immediate quadrants

| | | |
|---|---|---|
| 11 | 3a | 3b |
| 12 | 3d | 3c |
| 13 | 3a | 3d |
| 14 | 3b | 3c |

Extended quadrants 1

| | | |
|---|---|---|
| 15 | 4a | 4b |
| 16 | 4c | 4d |
| 17 | 4e | 4f |
| 18 | 4g | 4h |

Extended quadrants 2

| | | |
|---|---|---|
| 19 | 4a + 4b | 4c + 4d |
| 20 | 4e + 4f | 4g + 4h |
| 21 | 4c + 4d | 4e + 4f |
| 22 | 4a + 4b | 4g + 4h |

Additionally, in order to maximize the amount of information being encoded in the fixed number of bits, the probability of a digital 0 and 1 appearing at a given position should be equal. For a given training dataset, and for every bit corresponding to a particular region comparison, the number of ones versus the number of zeros can be altered by applying a weighting modifying the comparison.

Fingerprint Indexing and Comparison

The fingerprint allows indexing techniques similar to other indexing approaches utilizing local features [2]. For every extracted fingerprint it can indexed in a hash table as the hash key. The corresponding hash value can be composed of two terms: (i) the ID of the audio material the fingerprint belongs to, and (ii) the time elapsed from the beginning of the audio material in which the salient peak has been found. Retrieval of acoustic copies can be implemented in a standard way by defining an appropriate distance between any pair of two fingerprints.

Given the particular properties of the proposed fingerprint and the way it is extracted a novel way is proposed to compare any two fingerprints. In particular, it is proposed the usage of a modified Hamming distance where each bit position is weighted by the importance of that bit in the overall similarity of both fingerprints. Given two fingerprints fp₁[n] and fp₂[n] with nε[0, N−1] where N is the total dimension of the fingerprint, a weighting vector w[n] is defined, where n between [0, N−1] and

$${\sum }_{i = 0}^{N - 1} w [ i ] = N$$

whose elements w[i] reflect the importance of each bit in the comparison. Then, the Hamming distance is obtained as:

$$Hamm ( {fp}_{1} , {fp}_{2} ) = {\sum }_{i = 0}^{N - 1} w [ i ] * \{ \begin{matrix}1 & {fp}_{1} [ i ] = {fp}_{2} [ i ] \\ 0 & {fp}_{1} [ i ] \neq {fp}_{2} [ i ]\end{matrix}$$

Alternatively, the previous equation can be modified to treat differently the two different parts of the fingerprint in the following way: the 4 or 5 initial bits encoding the band where the salient peak was found can be converted to a natural number and compared first. Only when the location of both peaks is identical or very similar it is computed the hamming distance on the second part as mentioned above, otherwise both fingerprints are considered totally different. When a very fast comparison between bands is required, the conversion of the band information into a natural number and its comparison by subtracting both values can be avoided by using a small (4/5 bits, leading at most to a 256 or 1024 positions table) lookup table.

In order to obtain a suitable weighting vector it is proposed to extract and use for matching additional information regarding the individual region comparisons within the mask. Given a set of training data (which can be the reference database being indexed) they are computed the statistics on the percentage of times that the energy differences between two regions are close to each other (i.e. they are less than 10% different). Once all statistics have been computed such information can be used to rank the bits according to their discriminative power and give them more or less importance in the comparison. Additionally, the correlation between the different bits in the fingerprint can also be taken into account in order to assign a smaller overall weight to those pairs of bits with higher mutual information as their contribution to the fingerprint is more redundant.

Implementation

The method is suitable for implementation in a client-server architecture, or entirely in the server, depending on the application requirements. The method is typically implemented as software running on these types of devices, with individual steps most efficiently implemented as independent software modules.

In a possible embodiment the server can be a computer system, a distributed computer system or any kind of similar computer device with a program storage device accessible by this device, tangibly embodying a program of instructions executable by it to perform method steps for the above method. In addition, the client device can be any sort of mobile device (such a mobile phone, smartphone, PDA, tablet, etc.) or any other kind of device with capability to store and/or record input audio and a way to communicate with the server.

In this embodiment the server is used to index the extracted fingerprints from the audio in a scalable manner, so that search and retrieval of similar content can be done most effectively. This can involve the link of the server with a database or other means of storage and fast access devices. On the client device the audio can be either already stored locally on the device and in digital form (for example from the collection of music that the user has) or can be captured from any streaming source with the use of a microphone and a digital-to-analogue conversion circuit.

Once the audio is accessible inside the client device (either entirely or partially, thanks to streaming), the client device can opt to either extract the fingerprints as explained in the method before it sends such information to the server, or it can send directly the signal for the server to perform the extraction itself. Such decision depends on the nature of the connectivity between server and client (i.e. a slow or fast connection) and the processing capabilities of the client. In the transmission of such content it is possible to encode the information so that it is transmitted securely.

In this same embodiment the client is also able to capture audio information that is then indexed by the server, without performing any retrieval for acoustic copies. Such information can be later accessible by the server for comparing audio copies in it, given other acquired audio segments.

On another possible embodiment a single hardware device performs both the capture/retrieval of the audio content and posterior processing to either index it into the database or to find the possible copies already present in it. In such case this hardware device has access to Internet or any other internal networks that can provide it with the content to be indexed and also with the content that needs to be searched for. In a possible embodiment both the content being indexed and the content being searched for are identical, and the system performs a search of the content to itself, being able to structure such content according to the places where similar content exists.

The following are possible applications of the proposed invention:
Identification of music given a small portion of a known song, even if affected by noise or other artefacts. The recording device can be any program in a desktop computer/server or a mobile device.
Media monitoring in order to identify when some content in radio or TV has been repeated. Such invention can be applied to advertisements, jingles or any other kind of programs.
Organization of big media databases by detection of repeated materials, which allows reducing the storage by eliminating redundancies.
Copyright infringement to detect copied materials, either on recorded media or radio/TV transmissions.
Law enforcement in cases of search for illegal content in suspects media.

The following are the main novelties of the invention that are therefore its advantages in comparison to existing solutions:
The proposed fingerprint is local and characterizes individual salient spectral points and their immediate surroundings. This is in contrast to other local methods since they encode relative positions of more than one salient points. Therefore, the proposed method is more robust when used in retrieval applications than other methods as it is more probable for single salient point fingerprints to be resilient to acoustic transformations.
The required storage per every salient point is reduced as it is encoded only once, without the need to store several combinations of each salient point with its neighbouring points.
A mask centered around each salient point is used to define regions of interest, i.e. groups of values in the spectrogram which are believed to contain similar characteristics and to be useful to later distinguish between fingerprints. These regions can encode different sorts of information, like for example where the energy flows around the salient peak.
Spectral neighborhoods of each salient point are characterized by encoding differences in average energies of regions around it. The regions being compared are defined by using a mask centered on each salient point. Differently from other solutions, the compared values are computed over regions consisting of several spectral values, obtaining more discriminative and robust estimations of the energies in those regions.
The proposed fingerprint encodes the location of the salient peaks. However, in this case it is encoded using the MEL-frequency bands, and not the exact frequency. This reduces the storage requirements and allows very fast comparisons between fingerprints by using a lookup table. In other embodiments other filterbank methods can be used, in a similar way to the MEL-frequency bands, to encode the location of the peaks.
The distance between fingerprints can be efficiently done in two steps. In a first step the location of the salient peaks is compared. Only if such peaks are close enough the binary information encoded following the peak location is compared by using a modified Hamming distance. The Hamming distance is modified in order to weight each bit according to the relative importance that each bit brings to the system. The importance of each bit can be efficiently computed from the data being indexed by comparing the differences of energies in each binary assignment.

A person skilled in the art could introduce changes and modifications in the embodiments described without departing from the scope of the invention as it is defined in the attached claims.

### ACRONYMS

HAS Human Auditory Filter

FFT Fast Fourier Transform

PDA Personal Digital Assistant

### REFERENCES

[1] P. Cano, E. Bathe, T. Kalker, and J. Haitsma, “A review of algorithms for audio fingerprinting,” in Proc. Interna-tional Workshop on Multimedia Signal Processing, 2002.
[2] Avery Wang, “An industrial strength audio search algo-rithm,” in Proc. International Symposium on Music In-formation Retrieval, 2003.
[3] Antonius Kalker Jaap Haitsma, “A highly robust audio fingerprinting system,” in Proc. International Symposium on Music Information Retrieval (ISMIR), 2002.
[4] Shumeet Baluja and Michele Covell, “Audio fingerprint-ing: Combining computer vision and data-stream pro-cessing,” in Proc. IEEE International Conference on Acoustics, Speech, and Signal Processing, 2007.

1. A method to generate audio fingerprints, said audio fingerprints encoding information of audio documents, characterised in that it comprises:
a) centering a mask in a spectral peak of a plurality of spectral peaks of a spectrogram of an audio signal;
b) defining spectral regions around said spectral peak by means of said mask;
c) capturing average energies of each of said spectral regions;
d) comparing each of said average energies between them;
e) obtaining a bit for each comparison, each obtained bit indicating the result of each comparison,
f) grouping each bit obtained by means of said comparison in order to constitute an audio fingerprint; and
g) encoding of the encoded spectral peaks using coarse frequency bands in order to allow for fast comparison of fingerprints

2. A method as per claim 1, comprising performing said step a) in different spectral peaks of said plurality of spectral peaks in order to generate a plurality of audio fingerprints.

3. A method as per claim 2, wherein values of each bit obtained from said comparison of step e) depend on the spectral region that has a higher average energy according to said comparison.

4. A method as per claim 1, comprising including in said audio fingerprint the position of said spectral peak quantized by means of a Mel-spectrogram or any similar frequency bandpass filtering method.

5. A method as per claim 1, comprising performing a time-to-frequency transformation to said audio signal and possibly applying a Human Auditory System filtering to said frequency transformation in order to obtain said spectrogram, previous to said step a).

6. A method as per claim 5, comprising selecting spectral peaks of said spectrogram by means of selecting one of the following criteria to be applied: local maxima of said spectrogram, local minima of said spectrogram, inflection points of said spectrogram or derived points of said spectrogram

7. A method as per claim 6 comprising selecting a peak in of said spectrogram if E(t,f)>E(t+1,f), E(t,f)>E(t−1,f), E(t,f)>E(t,f+1) and E(t,f)>E(t,f−1), where t represents time variable, f represents frequency variable and E represents energy of said peak.

8. A method as per claim 6, wherein each of said spectral regions is a single time-frequency value of said spectrogram or a set of spectrogram values, said spectrogram values having similar characteristics according to time variable and/or frequency variable.

9. A method as per claim 8, comprising calculating the average energy of a spectral region composed of a set of spectrogram values as the arithmetic average of set spectrogram values.

10. A method as per claim 8, wherein a spectral region overlaps with a different spectral region.

11. A method as per claim 6, wherein said spectrogram is a frequency filter for bandpass filtering the spectral bands in a finite number of bands.

12. A method as per claim 11, wherein said spectrogram is a MEL spectrogram and said mask covers a determined number of MEL frequency bands around a spectral peak of said MEL spectrogram.

13. A method as per claim 12, comprising defining an audio fingerprint by gathering a block of bits encoding the MEL frequency band of said spectral peak and a block of bits resulting from said comparison performed in said step d).

14. A method as per claim 1, comprising assigning a hash value to said audio fingerprint, said hash value composed of two terms:
an identification of the audio document that said audio fingerprint corresponds to; and
time elapsed from the beginning of said audio signal and the selection of a spectral peak.

15. A method as per claim 14, comprising comparing two different audio fingerprints by means of a Hamming distance.

16. A method as per claim 15, comprising treating separately said two terms of said audio fingerprint when calculating said Hamming distance.

17. A method as per claim 1, wherein said audio fingerprint has at least 16 bits long.

18. A method as per claim 1, wherein said audio signal is a static file or a streaming audio.

19. A method as per claim 1, wherein the fingerprint that characterizes each peak is constructed by combining an index of the frequency band where the peak being described is found and information from the masked area around it.

20. A method as per claim 1, further defining an audio fingerprint by gathering a block of bits encoding said frequency bands.
